(19) United States
(12) Patent Application Publication
(10) Pub. No.: US 2009/0173114 A1
(43) Pub. Date: Jul. 9, 2009

(54) Electric Door Lock

(75) Inventors: Lung-Yin Lin, Nan-Tou Hsien (TW); Chuan-Tien Fan, Taipei City (TW)

Correspondence Address: BINGHAM MCCUTCHEN LLP, 2020 K Street, N.W., Intellectual Property Department, WASHINGTON, DC, 20006, US

(73) Assignee: LONG CYUAN CO., LTD., Chiayi City (TW)

(21) Appl. No.: 11/968,900

(22) Filed: Jan. 3, 2008

(51) Int. Cl. E05B 47/02; E05B 65/00

(52) U.S. Cl. 70/91

(57) ABSTRACT

An electric door lock includes a driving module and a control module. The driving module is operable between locking and unlocking modes. The control module includes a switch unit and a manual operating member. The switch unit is operable so as to deactivate the driving module when actuated. The manual operating member includes a shaft that extends rotatably into the lock housing, that has an actuating protrusion, and that is rotatable relative to the lock housing between locking and unlocking positions. When the driving module is operated in the locking mode, the shaft of the manual operating member is disposed at the locking position and the actuating protrusion actuates the switch unit. When the driving module is operated in the unlocking mode, the shaft of the manual operating member is disposed at the unlocking position and the actuating protrusion actuates the switch unit.

### BACKGROUND OF THE INVENTION

1. Field of the Invention

This invention relates to a door lock, more particularly to an electric door lock.

2. Description of the Related Art

In Taiwanese Patent Application Publication No. 475640, there is disclosed a conventional electric door lock, as illustrated in FIG. 1. The conventional electric door lock includes a lock housing 11, a driving module 12, and a control module 13. The driving module 12 is operable between locking and unlocking modes. In particular, the driving module 12 includes a gear assembly 121 and a motor 122. The gear assembly 121 is mounted rotatably in the lock housing 11. The motor 122 is mounted in the lock housing 11, is coupled to the gear assembly 121, and is operable so as to drive rotation of the gear assembly 121. The gear assembly 121 is rotatable relative to the lock housing 11 in a first rotational direction when the driving module 12 is operated in the locking mode, and a second rotational direction opposite to the first rotational direction when the driving module 12 is operated in the unlocking mode. The control module 13 includes a switch unit and a manual operating member. The switch unit includes angularly spaced first and second contact switches 131, 132 that are mounted in the lock housing 11, that are coupled to the driving module 12, and that are operable so as to deactivate the motor 122 of the driving module 12 when actuated. The manual operating member includes a shaft 133 that extends rotatably into the lock housing 11, that is coupled to the gear assembly 121 of the driving module 12, a plate 134 that is sleeved securely on the shaft 133 thereof so as to be co-rotatable therewith, and an actuating protrusion 135 that is connected to the plate 134 thereof. The shaft 133 is rotatable relative to the lock housing 11 between a locking position, where the actuating protrusion 135 actuates the first contact switch 131, and an unlocking position, where the actuating protrusion 135 actuates the second contact switch 132.

In operation, at an initial position, in which the shaft 133 of the manual operating member is disposed at the unlocking position, when it is desired to operate the driving module 12 in the locking mode, the motor 122 of the driving module 12 is activated, such as with the use of a remote controller (not shown) or a magnetic card (not shown). This results in rotation of the gear assembly 121 of the driving module 12 in the first rotational direction, co-rotation of the shaft 133 and the plate 134 of the manual operating member from the unlocking position to the locking position, actuation of the first contact switch 131 of the switch unit by the actuating protrusion 135 of the manual operating member, and deactivation of the motor 122 of the driving module 12. Thereafter, when it is desired to operate the driving module 12 in the unlocking mode, the motor 122 of the driving module 12 is reactivated. This results in rotation of the gear assembly 121 of the driving module 12 in the second rotational direction, co-rotation of the shaft 133 and the plate 134 of the manual operating member from the locking position back to the unlocking position, actuation of the second contact switch 132 of the switch unit by the actuating protrusion 135 of the manual operating member, and deactivation of the motor 122 of the driving module 12.

Although the aforementioned conventional electric door lock achieves its intended purpose, the manual operating member thereof unnecessarily includes the plate 134. This gives rise to higher production costs.

### SUMMARY OF THE INVENTION

Therefore, the object of the present invention is to provide an electric door lock that can overcome the aforesaid drawback of the prior art.

According to an aspect of the present invention, an electric door lock comprises a lock housing, a driving module, and control module. The driving module is mounted in the lock housing, and is operable between locking and unlocking modes. The control module includes a switch unit and a manual operating member. The switch unit is mounted in the lock housing, is coupled to the driving module, and is operable so as to deactivate the driving module when actuated. The manual operating member includes a shaft. The shaft extends rotatably into the lock housing, has an outer surface formed with at least one actuating protrusion, and is rotatable relative to the lock housing between locking and unlocking positions. When the driving module is operated in the locking mode, the shaft of the manual operating member is disposed at the locking position and the actuating protrusion actuates the switch unit. When the driving module is operated in the unlocking mode, the shaft of the manual operating member is disposed at the unlocking position and the actuating protrusion actuates the switch unit.

According to another aspect of the present invention, a control module for an electric door lock comprises a switch unit and a manual operating member. The electric door lock includes a lock housing, and a driving module that is mounted in the lock housing and that is operable between locking and unlocking modes. The switch unit is adapted to be mounted in the lock housing and to be coupled to the driving module. The switch unit is operable so as to deactivate the driving module when actuated. The manual operating member includes a shaft. The shaft is adapted to extend rotatably into the lock housing, has an outer surface formed with at least one actuating protrusion, and is rotatable relative to the lock housing between locking and unlocking positions. When the driving module is operated in the locking mode, the shaft of the manual operating member is disposed at the locking position and the actuating protrusion actuates the switch unit. When the driving module is operated in the unlocking mode, the shaft of the manual operating member is disposed at the unlocking position and the actuating protrusion actuates the switch unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional electric door lock;

FIG. 2 is a schematic view of the first preferred embodiment of an electric door lock according to the present invention;

FIG. 3 is a schematic view to illustrate a knob of a manual operating member of the first preferred embodiment;

FIGS. 4 and 5 are schematic views to illustrate a state where a shaft of the manual operating member of first preferred embodiment is disposed at an unlocking position; and

FIG. 6 is a schematic view of the second preferred embodiment of an electric door lock according to the present invention.

### DETAILED DESCRIPTION OF THE PREFERRED EMBODIMENTS

Before the present invention is described in greater detail, it should be noted that like elements are denoted by the same reference numerals throughout the disclosure.

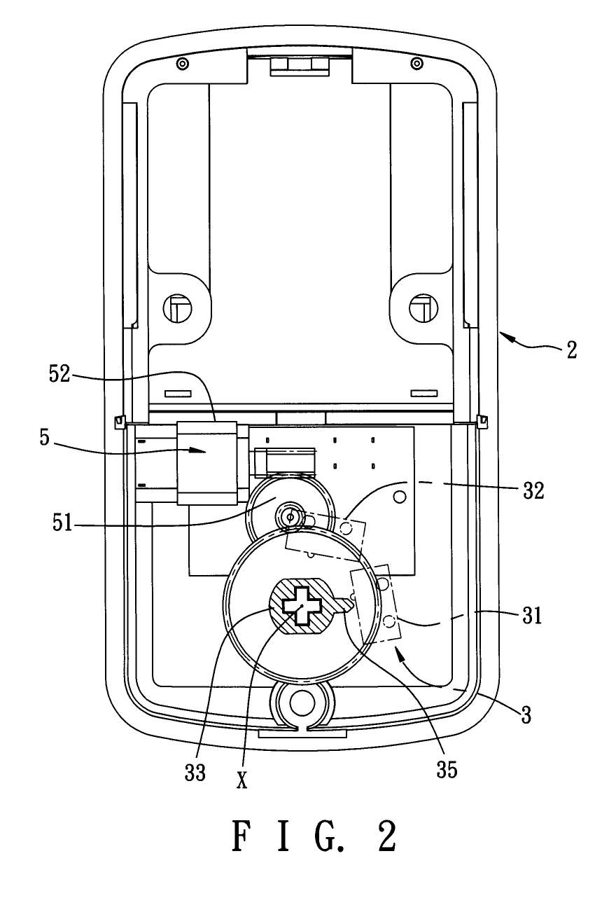

Referring to FIG. 2, the first preferred embodiment of an electric door lock according to this invention is shown to include a lock housing 2, a driving module 5, and a control module 3.

The lock housing 2 defines an axis (X).

The driving module 5 is operable in locking and unlocking modes. In particular, the driving module 5 includes a gear assembly 51 and a motor 52. The gear assembly 51 is mounted rotatably in the lock housing 2. The motor 52 is mounted in the lock housing 2, is coupled to the gear assembly 51, and is operable so as to drive rotation of the gear assembly 51. The gear assembly 51 is rotatable relative to the lock housing 2 in a first rotational direction when the driving module 5 is operated in the locking mode, and a second rotational direction opposite to the first rotational direction when the driving module 5 is operated in the unlocking mode.

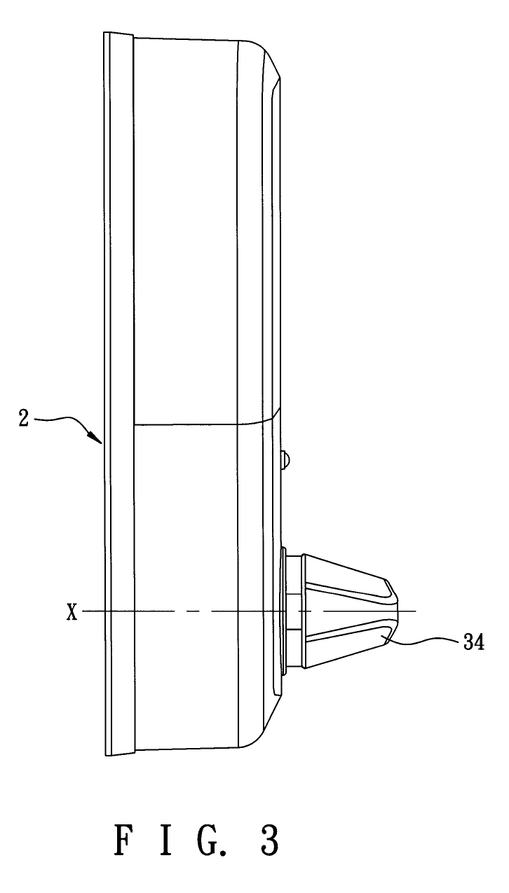

The control module 3 includes a switch unit and a manual operating member. The switch unit includes angularly spaced first and second contact switches 31, 32 that are mounted in the lock housing 2, that are coupled to the motor 52 of the driving module 5, and that are operable so as to deactivate the motor 52 of the driving module 5 when actuated. The manual operating member includes a shaft 33 and a knob 34 (see FIG. 3). The shaft 33 of the manual operating member extends rotatably into the lock housing 2, is coupled to the gear assembly 51 of the driving module 5, and has an outer surface formed with an actuating protrusion 35. In this embodiment, the shaft 33 is rotatable relative to the lock housing 2 about the axis (X) between a locking position, where the actuating protrusion 35 actuates the first contact switch 31, and an unlocking position, where the actuating protrusion 35 actuates the second contact switch 32. The knob 34 of the manual operating member is disposed externally of the lock housing 2, and is connected to the shaft 33 of the manual operating member so as to be co-rotatable therewith between the locking and unlocking positions.

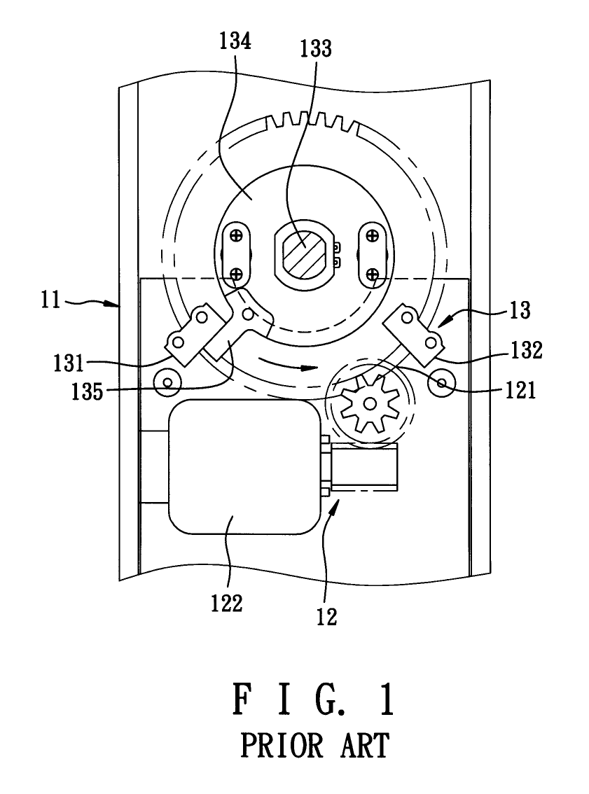

In this embodiment, the shaft 33 and the actuating protrusion 35 are formed as a single piece. As such, the manual operating member of the electric door lock of this invention may dispense with the plate 133 of the manual operating member of the conventional electric door lock (see FIG. 1).

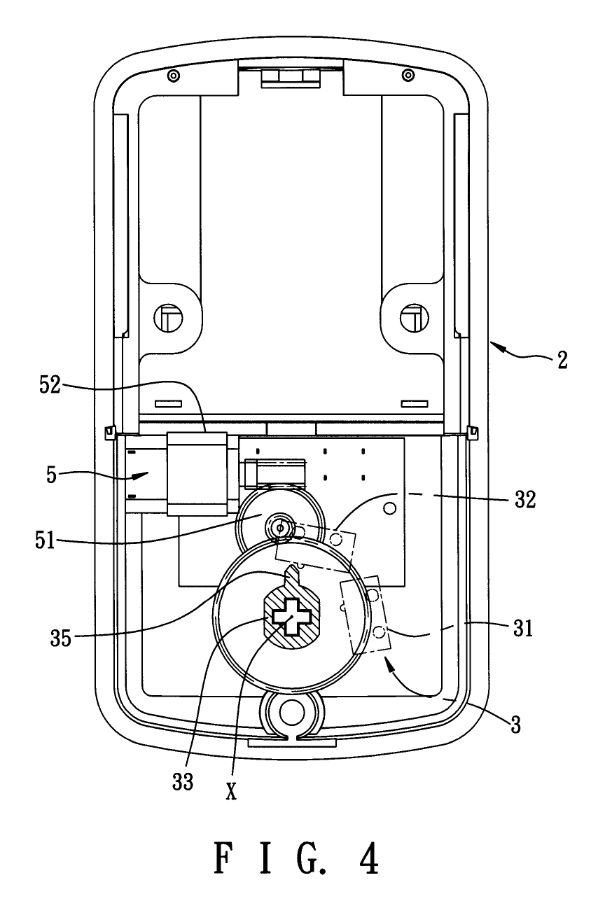

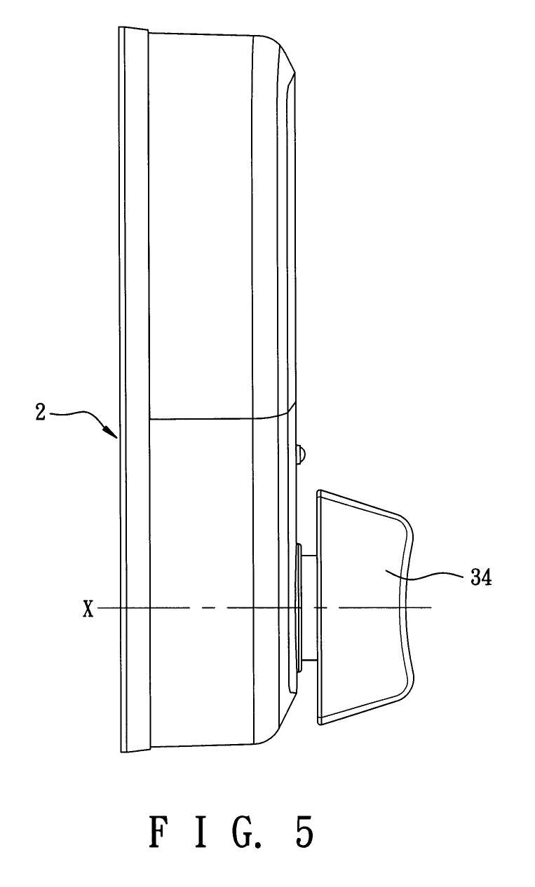

In operation, at an initial position, in which the shaft 33 and the knob 34 of the manual operating member are disposed at the locking position, as best shown in FIGS. 2 and 3, when it is desired to operate the driving module 5 of the electric door lock of this invention in the unlocking mode, the motor 52 of the driving module 5 is activated, such as with the use of a remote controller (not shown) or a magnetic card (not shown). This results in rotation of the gear assembly 51 of the driving module 5 in the second rotational direction, co-rotation of the shaft 33 and the knob 34 of the manual operating member about the axis (X) from the locking position to the unlocking position, as best shown in FIGS. 4 and 5, actuation of the second contact switch 32 of the switch unit by the actuating protrusion 35 of the manual operating member, as best shown in FIG. 4, and deactivation of the motor 52 of the driving module 5. Thereafter, when it is desired to operate the driving module 5 of the electric door lock of this invention in the locking mode, the motor 52 of the driving module 5 is reactivated. This results in rotation of the gear assembly 51 of the driving module 5 in the first rotational direction, co-rotation of the shaft 33 and the knob 34 of the manual operating member about the axis (X) from the unlocking position back to the locking position, as best shown in FIGS. 2 and 3, actuation of the first contact switch 31 of the switch unit by the actuating protrusion 35 of the manual operating member, as best shown in FIG. 2, and deactivation of the motor 52 of the driving module 5.

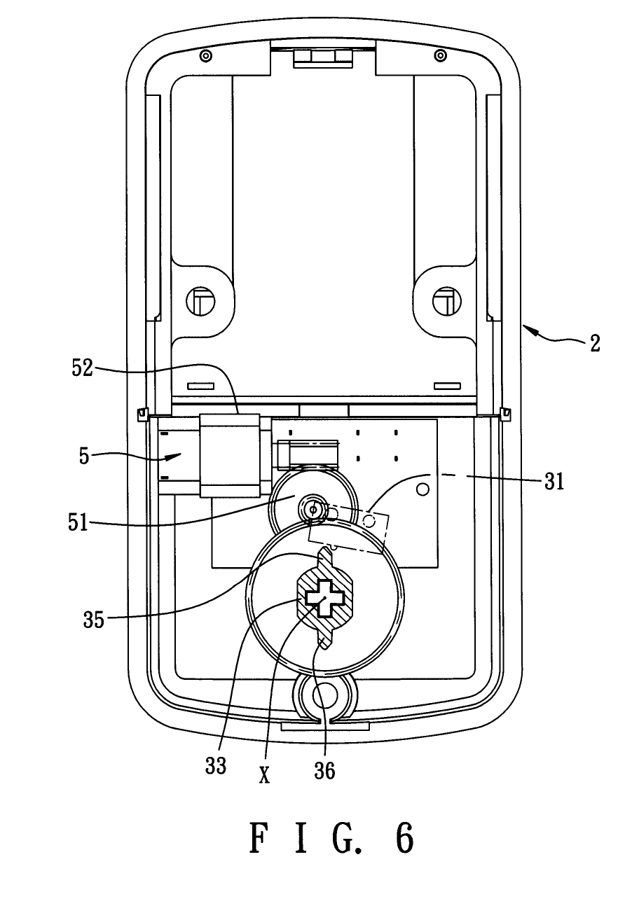

FIG. 6 illustrates the second preferred embodiment of an electric door lock according to this invention. When compared to the previous embodiment, the switch unit dispenses with the second contact switch 32 (see FIG. 2). The outer surface of the shaft 33 of the manual operating member is formed with a pair of the actuating protrusions 35, 36.

In operation, at an initial position, in which the shaft 33 of the manual operating member is disposed at the locking position, when it is desired to operate the motor 52 of the driving module 5 of the electric door lock of this invention in the unlocking mode, the motor 52 of the driving module 5 is activated. This results in rotation of the gear assembly 51 of the driving module 5 in the second rotational direction, co-rotation of the shaft 33 and the knob (not shown) of the manual operating member from the locking position to the unlocking position, actuation of the first contact switch 31 of the switch unit by the actuating protrusion 35 of the manual operating member, and deactivation of the motor 52 of the driving module 5. Thereafter, when it is desired to operate the motor 52 of the driving module 5 of the electric door lock of this invention in the locking mode, the motor 52 of the driving module 5 is reactivated. This results in rotation of the gear assembly 51 of the driving module 5 in the first rotational direction, co-rotation of the shaft 33 and the knob of the manual operating member from the unlocking position back to the locking position, actuation of the first contact switch 31 of the switch unit by the actuating protrusion 36 of the manual operating member, and deactivation of the motor 52 of the driving module 5.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electric door lock, comprising:
a lock housing;
a driving module mounted in said lock housing, and operable between locking and unlocking modes; and
a control module including
a switch unit that is mounted in said lock housing, that is coupled to said driving module, and that is operable so as to deactivate said driving module when actuated, and
a manual operating member that includes a shaft, said shaft extending rotatably into said lock housing, having an outer surface formed with at least one actuating protrusion, and being rotatable relative to said lock housing between locking and unlocking positions;
wherein when said driving module is operated in the locking mode, said shaft of said manual operating member is disposed at the locking position and said actuating protrusion actuates said switch unit; and
wherein when said driving module is operated in the unlocking mode, said shaft of said manual operating member is disposed at the unlocking position and said actuating protrusion actuates said switch unit.

2. The electric door lock as claimed in claim 1, wherein said shaft of said manual operating member and said actuating protrusion are formed as a single piece.

3. The electric door lock as claimed in claim 1, wherein said switch unit includes a first contact switch that is actuated by said actuating protrusion of said manual operating member when said shaft of said manual operating member is disposed at the locking position, and a second contact switch that is actuated by said actuating protrusion of said manual operating member when said shaft of said manual operating member is disposed at the unlocking position.

4. The electric door lock as claimed in claim 1, wherein said switch unit includes a contact switch, and said outer surface of said shaft of said manual operating member includes a pair of said actuating protrusions,
one of said actuating protrusions actuating said contact switch of said switch unit when said shaft of said manual operating member is disposed at the locking position,
the other one of said actuating protrusions actuating said contact switch of said switch unit when said shaft of said manual operating member is disposed at the unlocking position.

5. The electric door lock as claimed in claim 1, wherein said manual operating member includes a knob disposed externally of said lock housing, and connected to said shaft so as to be co-rotatable therewith.

6. A control module for an electric door lock, the electric door lock including a lock housing, and a driving module that is mounted in the lock housing and that is operable between locking and unlocking modes, said control module comprising:
a switch unit adapted to be mounted in the lock housing and to be coupled to the driving module, said switch unit being operable so as to deactivate the driving module when actuated; and
a manual operating member including a shaft, said shaft being adapted to extend rotatably into the lock housing, having an outer surface formed with at least one actuating protrusion, and being rotatable relative to the lock housing between locking and unlocking positions;
wherein when the driving module is operated in the locking mode, said shaft of said manual operating member is disposed at the locking position and said actuating protrusion actuates said switch unit; and
wherein when the driving module is operated in the unlocking mode, said shaft of said manual operating member is disposed at the unlocking position and said actuating protrusion actuates said switch unit.

7. The control module as claimed in claim 6, wherein said shaft of said manual operating member and said actuating protrusion are formed as a single piece.

8. The control module as claimed in claim 6, wherein said switch unit includes a first contact switch that is actuated by said actuating protrusion of said manual operating member when said shaft of said manual operating member is disposed at the locking position, and a second contact switch that is actuated by said actuating protrusion of said manual operating member when said shaft of said manual operating member is disposed at the unlocking position.

9. The control module as claimed in claim 6, wherein said switch unit includes a contact switch, and said outer surface of said shaft of said manual operating member includes a pair of said actuating protrusions,
one of said actuating protrusions actuating said contact switch of said switch unit when said shaft of said manual operating member is disposed at the locking position,
the other one of said actuating protrusions actuating said contact switch of said switch unit when said shaft of said manual operating member is disposed at the unlocking position.

10. The control module as claimed in claim 6, wherein said manual operating member includes a knob connected to said shaft thereof.
